(19) United States
(12) Patent Application Publication
(10) Pub. No.: US 2005/0033693 A1
(43) Pub. Date: Feb. 10, 2005

(54) Configuring an electronic device

(75) Inventor: Jani Olavi Toiminen, Tampere (FI)

Correspondence Address: Crawford Maunu PLLC, Suite 390, 1270 Northland Drive, St. Paul, MN, 55120, US

(73) Assignee: Nokia Corporation

(21) Appl. No.: 10/888,402

(22) Filed: Jul. 8, 2004

(30) Foreign Application Priority Data
Jul. 9, 2003 (FI) 20031047

(51) Int. Cl. G06F 17/60

(52) U.S. Cl. 705/43; 705/1

(57) ABSTRACT

The invention relates to configuring electronic devices in a sales situation. According to the invention, an automatic dispenser is provided, comprising a user interface for showing information to a user and for receiving user input in order to select an electronic device, means for configuring the electronic device in response to the user input, and means for providing the user with the electronic device from the automatic dispenser.

### FIELD OF THE INVENTION

The invention relates to configuring an electronic device, and particularly to configuring an electronic device in a sales situation.

### BACKGROUND OF THE INVENTION

Nowadays, device manufactures provide mobile terminals for retail dealers, who further sell the mobile terminals to consumers in retail shops. In connection with a purchase event, the aim is to configure the mobile terminals, i.e. to specify various settings in a mobile terminal to control its use, at a store, but a user may also have to configure his or her mobile terminal after the purchase event as well. A purchase event with simultaneous configuration of mobile terminals is often quite time-consuming. In addition, salespersons must be continuously trained to enable new mobile terminals and services to be configured, which increases costs incurred to the customer.

### BRIEF DESCRIPTION OF THE INVENTION

There are now provided an automatic dispenser, methods, a system and a computer software product according to the independent claims. Some preferred embodiments of the invention are disclosed in the dependent claims.

According to the invention, electronic devices, such as mobile terminals, are supplied by means of automatic dispensers developed for the purpose. According to an aspect of the invention, electronic devices may also be configured by means of automatic dispensers. Such automatic dispensers are particularly provided with a user interface for displaying information to a user and for receiving user input for selecting an electronic device, means for configuring the electronic device in response to the user input, and means for providing the user with the electronic device.

The arrangement of the invention enables electronic devices to be delivered directly to users without being tied to a particular retail dealer or a retail shop. Neither does the purchase of an electronic device have to be restricted to the opening hours of a shop. Electronic devices may be configured already by the automatic dispenser to be ready to use with no need for salespersons or for the user himself or herself to take care of the configuration. This enables the user to be provided with a working electronic device immediately after the purchase event. Automatization reduces the possibility of a human error when putting the electronic device to use, and there is no need to configure the electronic devices over a radio interface.

According to an embodiment of the invention, there is provided a configuration system wherein a separate configuration server is arranged to transfer configuration information to an automatic dispenser through a data transfer connection. The automatic dispenser is arranged to receive configuration information from the configuration server and feed configuration information to an electronic device to be configured. No need thus exists to store configuration information on different electronic devices in automatic dispensers but the configuration information may be centralized to the configuration server.

According to an embodiment of the invention, information on a purchase event is transmitted from an automatic dispenser to at least one external server. Depending on the implementation, this embodiment enables various advantages: For instance, information on a new mobile subscriber, new services in particular, may be delivered through an information network to an information system of a network operator and/or a service provider, which enables a user and a sold mobile terminal to be quickly provided with access to a mobile communication network and/or new services. According to an embodiment, subscriber information is delivered to a subscriber register of a network operator, such as an HLR (Home Location Register), which comprises information on authorized subscribers and their services. According to another embodiment, information on a new mobile terminal, such as an IMEI identity (International Mobile Equipment Identity), is transmitted to an equipment identity register of a network operator. Information on sold mobile terminals and users thereof may be collected almost real-time, which, for instance, means that a manufacturer of mobile terminals is provided with up-to-date information on sales figures.

### BRIEF DESCRIPTION OF THE DRAWINGS

The invention is now described in closer detail in connection with some embodiments and with reference to the accompanying drawings, in which

FIG. 1 shows an automatic dispenser according to an embodiment of the invention;

FIG. 2 shows functions and interfaces to other devices of an automatic dispenser according to an embodiment;

FIG. 3 is a flow diagram illustrating a method according to an embodiment of the invention; and

FIG. 4 is a flow diagram illustrating in closer detail a process of configuring a mobile terminal according to an embodiment of the invention.

### DETAILED DESCRIPTION OF THE INVENTION

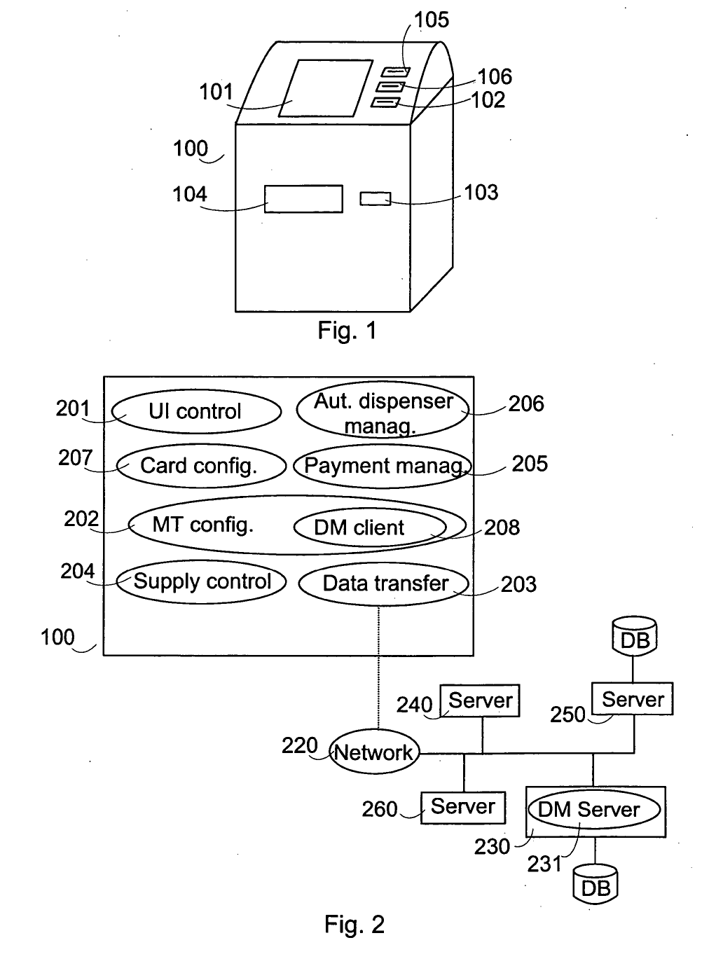

FIG. 1 shows an automatic dispenser 100 according to an embodiment of the invention, suitable for supplying mobile terminals and/or IC cards in particular. It is to be noted, however, that the invention may also be applied to supply and configuration of electronic devices of another type, such as to development of automatic dispensers suitable for supply and configuration of PDA devices, game consoles and cameras. The automatic dispenser 100 comprises a reading module 102 for an IC (Integrated Circuit) card or another memory card, an IC card supply module 103, a mobile terminal supply module 104, and a display module 101. According to an embodiment, a user interface of the automatic dispenser 100 is arranged through the display module 101, which provides a touch screen, but user interface means of another type are also feasible. In addition to a common display, the automatic dispenser 100 may comprise e.g. a keyboard, a mouse or another resource cursor, a microphone, and a loudspeaker.

The reading module 102 is provided particularly for inserting a payment card, identifying a user, or authorizing payment. The module 102 comprises a slot wherein a card may be inserted, locking elements for locking a card, and a card reader for reading information e.g. through contacts of an IC card or from a magnetic stripe on a magnetic card. It is thus to be notified that in addition to or instead of an IC card-reading module 102, the automatic dispenser 100 may be provided with a module 105 for reading a magnetic stripe card. Already well known card readers may be used. The automatic dispenser 100 may support several bank cards, credit cards and electronic identification cards of different type.

According to an embodiment, the automatic dispenser 100 comprises an IC card supply module 103, which enables a user to be provided with an IC card according to the services selected by the user, e.g. an IC card comprising a SIM application of a GSM system. The automatic dispenser 100 is then provided with a container for IC cards, from which, utilizing a transfer mechanism, an IC card may be transferred to a slot in a wall of the automatic dispenser. The automatic dispenser 100 may also comprise other modules 106, e.g. readers for different card standards. According to an embodiment, the module 106 may also comprise writing means, in which case it may be used for writing information onto an IC card, e.g. for modifying an IC card comprising a user's SIM application. It is also possible to implement writing means in the module 102 for writing or changing information in a memory of a card inserted into the module.

The mobile terminal supply module 104 comprises a compartment to which a mobile terminal may be transferred and from which a user may obtain the mobile terminal. Instead of such a compartment, any supply means of another type, e.g. an opening from which a mobile terminal partly emerges from the automatic dispenser 100, may be used. The automatic dispenser 100 comprises a transfer mechanism for transferring mobile terminals between the mobile terminal container and the compartment. The automatic dispenser 100 further comprises e.g. a selection mechanism for selecting, in accordance with a control command received from a control function, a correct mobile terminal from the container (or a correct container if different mobile terminals are stored in different containers). Numerous already existing mechanical solutions developed for other automated equipment may be utilized for implementing the transfer and selection mechanisms. It is also possible to store IC cards and/or mobile terminals outside the automatic dispenser 100, in which case the automatic dispenser 100 has to be provided with transfer means for transferring mobile terminals thereto. The appearance of the automatic dispenser may resemble already existing automatic dispensers, e.g. an automatic beverage dispenser. It is to be notified, however, that as distinct from FIG. 1, some of the functions of the automatic dispenser 100 may be decentralized to different devices, e.g. the supply of mobile terminals may be arranged to take place through a compartment provided in a wall next to the automatic dispenser.

FIG. 2 illustrates functions and interfaces to other devices of an automatic dispenser 100. The automatic dispenser 100 comprises a user interface control block 201, which controls a user interface, such as a display module 101, receives user input therefrom, and transmits different information to be shown to a user thereto. A mobile terminal configuration block 202 is responsible for configuring a mobile terminal in accordance with user input and configuration information. According to an embodiment, the configuration block 202 comprises a device management client application, which receives device management commands containing configuration information from a device management server 231 external to the automatic dispenser.

A data transfer block 203 is responsible for arranging the internal and external data transfer of the automatic dispenser 100. The automatic dispenser 100 comprises a transceiver for arranging telecommunication to external networks 220, typically the Internet. Connections may be arranged using wired techniques, using e.g. DSL techniques or Ethernet techniques. According to an embodiment, connections are arranged using wireless techniques, using e.g. cellular network connections (e.g. GSM or WCDMA) or wireless local area network techniques, in which case the automatic dispenser 100 is better suited for being moved from a location to another. Since the automatic dispenser comprises processing confidential information, access to the automatic dispenser 100 is prevented as far as both physical access (e.g. by means of electrical locks) and information security are concerned. The block 203 may comprise firewall software with a high information security level to monitor all data transfer between the automatic dispenser 100 and an external network 220. According to an embodiment, information fed to the automatic dispenser 100 by the user and information on a sales event determined by the automatic dispenser may be delivered to external servers 230, 240, 250, 260 in particular, and, on the other hand, information to be shown to the user may be received from a server 230, 240, 250, 260 to control the operation of the automatic dispenser 100 and to configure a mobile terminal to be sold.

A supply control block 204 is responsible for controlling the storage and supply of mobile terminals, i.e. when necessary, the block controls the mechanical selection and supply elements so that a correct mobile terminal becomes selected and transferred to the supply module 104. According to an embodiment, IC cards may also be provided from the automatic dispenser, in which case the block 204 also controls the selection of IC cards and supplying them to a user, or a separate control block is provided for IC cards.

A payment management block 205 is responsible for authorizing payment and identifying a user, typically on the basis of an identification and payment card of the user inserted into the automatic dispenser 100 and information received from the user at a user interface 101. Typically, the block 205 uses an external element, such a server 240 of a credit institution, for verifying the identity of a user and/or confirming payment. The block 205 may e.g. transmit a user identifier received from the user's payment card to the server 240 of a bank, which transmits a verification of the user's capacity to pay and/or charges the user's account. An automatic dispenser management block 206 is responsible for configuring the automatic dispenser 100 while a card configuration block 207 is responsible for configuring an IC card.

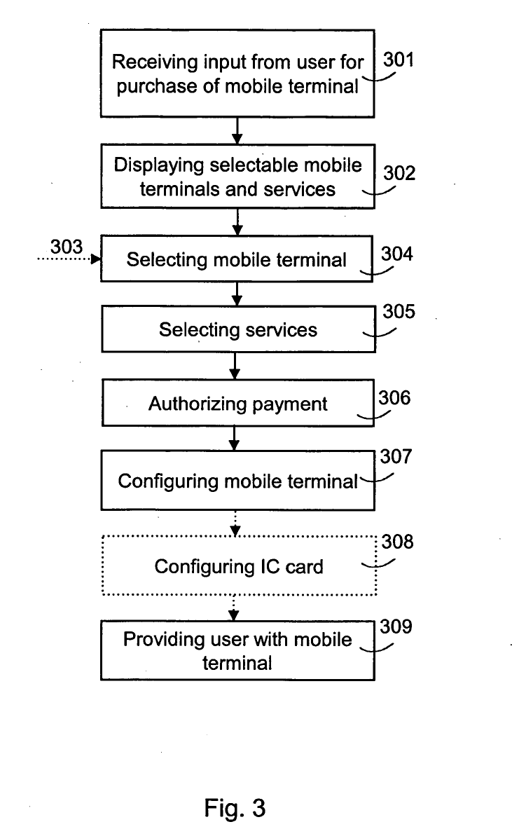

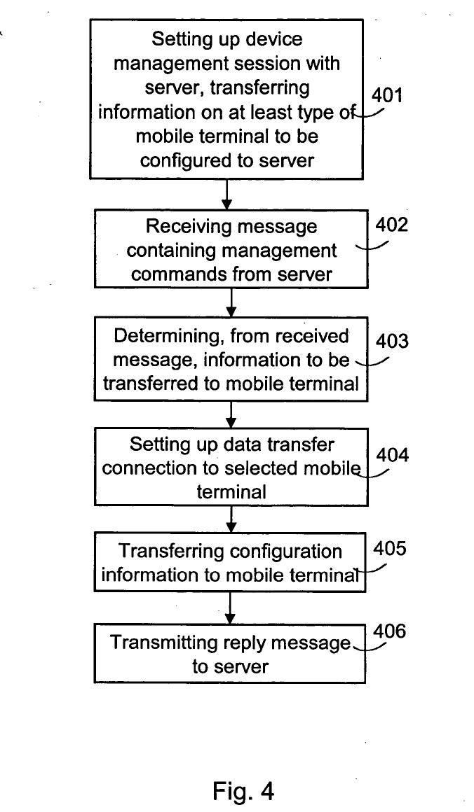

A person skilled in the art understands that the functions of the blocks shown in FIG. 2 may also be arranged in different ways and that they may require several separate blocks. For instance, instead of one data transfer block 203, the automatic dispenser 100 may comprise several separate control blocks for controlling different data transfer devices. The automatic dispenser 100 comprises at least one processing unit and memory to store computer programs to be executed in the processing unit. According to an embodiment, at least some of the blocks illustrated in FIG. 2 for controlling the operation of the automatic dispenser 100 are implemented by a computer program to be executed in the processing unit. By means of computer program codes to be executed in the processing unit, the automatic dispenser 100 can be made to implement the inventive means relating to selling, and configuring in particular, mobile terminals and/or IC cards, some of the embodiments thereof being illustrated in FIGS. 3 and 4. A computer program may be stored in any memory means, e.g. on a hard disk or a CD-ROM disc of a data processing device, from which it can be downloaded to the memory of a device 100 executing the program. A computer program may also be downloaded through a network, e.g. using a TCP/IP protocol stack. It is also possible to use hardware solutions or a combination of hardware and software solutions for implementing the inventive means.

FIG. 3 illustrates a method according to an embodiment of the invention to be applied to an automatic dispenser 100. In step 301, user input is received from a user. The input may be generated e.g. when the user presses a start icon on a touch screen 101. In response to the user input, selectable mobile terminals are displayed 302 on a user interface 101 of the automatic dispenser 100. The user may browse different mobile terminals and compare their features, and select a mobile terminal. The user may be shown images of different mobile terminals and information on their features and prices. The automatic dispenser may deliver the information to be shown on the user interface 101 from its own memory or from an external device, e.g. from a WWW server containing device information over the Internet.

On the basis of the input 303 received from the user, the mobile terminal to be bought and/or configured is selected 304. On the basis of services supported by the selected mobile terminal, the services are selected 305. The user may then be shown the services available in the mobile terminal, possibly also taking into account services supported by different network operators. The user may select the desired services, and in accordance with the input generated on the basis of the selection, the automatic dispenser 100 determines the configuration necessary for the mobile terminal.

After the services and the mobile terminal have been determined, the automatic dispenser 100 may determine an all-inclusive price to be shown to the user for payment authorization. The user is to select the manner of payment and enter information necessary for payment, user identification information in particular, into the automatic dispenser 100, for authorizing 306 payment. This information, such as a user identifier, can be obtained from an IC card, but to make sure that the user is a person authorized to use the card, e.g. a password or a fingerprint is also checked. A digital signature may also be used for authorizing payment. If the user accepts the payment, i.e. the user authorizes the payment, the automatic dispenser 100 may start authorizing 306 the payment to an external server. The automatic dispenser 100 may support many different manners of payment. Depending on the manner of payment, the payment may be authorized in many different ways. Typically, the automatic dispenser 100, directly or through a separate payment server of the possessor of the automatic dispenser, sets up a connection to the server 240 of a bank or another credit institution, to which the user's payment authorization to charge a credit card or a payment card is transmitted. The server processes the user's payment authorization. The server 240 transmits an authorization to the automatic dispenser 100 which, only after receiving the authorization, may deliver the mobile terminal to the user. The server 240 may transmit the authorization if the user has credit and/or the payment has been settled. An already existing technology for electronic commerce and messages specified therein may be utilized for authorizing or settling payment. For instance, SET (Source Electronic Transaction) technique may be used for transferring the information on a payment card entered into the automatic dispenser 100 over the Internet. It is also possible to utilize already existing network banking techniques in step 306.

If the payment has been authorized successfully, the selected mobile terminal can be configured in step 307. The configuration 307 may be implemented in many different ways by the block 202. According to an embodiment, the automatic dispenser 100 comprises an automatic mechanism whose elements are connectable to a mobile terminal in response to a need to configure the mobile terminal on the basis of a control signal received e.g. from the configuration block 202, a data cable through which the configuration block 202 is arranged to feed configuration information to the mobile terminal. The automatic mechanism may also connect e.g. a power supply cable (may also be provided within the data cable) to the mobile terminal. Typically, mobile terminals may thus be configured by means of a signal supplied through a cable with no need for a mobile terminal to comprise a common battery as a power source and with no need to switch on the mobile terminal by a switch key. According to another embodiment, the automatic dispenser 100 comprises a pin to switch on the mobile terminal to be configured, and when the mobile terminal has been switched on, configuration information is transferred thereto. It is also possible that each mobile terminal is electrically connected to a connector to enable configuration. Already existing connector solutions may be utilized in the automatic dispenser 100.

According to an embodiment, configuration 307 may be carried out utilizing a device management client application 208 in the automatic dispenser 100. Next, a data transfer connection may be set up between a mobile terminal and the automatic dispenser 100, the data transfer connection enabling the configuration block 202 of the mobile terminal to transfer the configuration information to the mobile terminal in accordance with a proprietary protocol or a device management standard. Stored therein, the automatic dispenser 100 may comprise configuration programs that have been mobile terminal specifically predetermined by a mobile terminal manufacturer, and based on the programs, settings can be stored in correct memory regions in the mobile terminal. The block 202 selects a correct program on the basis of the type of the selected mobile terminal. The block 202 may e.g. execute configuration software which is responsible for implementing a configuration program. It is also possible that the configuration information stored in the automatic dispenser 100 in advance or received from an external device contains device specific configuration information and/or program code such that no separate configuration programs need to be stored in advance in the automatic dispenser 100 for providing the mobile terminal with configuration information.

According to an embodiment, the automatic dispenser 100 transmits one or more messages to a server controlling network services, such as a server 230, 250, 260. Typically, prior to opening any services, the server controlling network services requires at least user identification information from the user. According to an embodiment, a connection is set up to a network management system of the particular network operator (that owns the SIM application), e.g. to the server 250 or the server 230 comprising a device management server application 231. The automatic dispenser 100 may transfer the information on new and/or modified services selected by the user. Since the configuration information necessary in the mobile terminal is typically network operator specific, an operator to which the information is transmitted has to be selected. Stored therein, the automatic dispenser 100 may comprise the network addresses or numbers of servers 230, 250, 260 of several different network operators typically operating in the particular area. For example, if the user has selected WAP services for his or her mobile terminal, the operator according to the operator identifier of a SIM application which the IC card of the user already has or which the IC card selected by the user already has, is informed that a WAP service was selected. In the services selection step 305, the user may also be shown service and price information on different operators stored in the automatic dispenser 100 or downloaded by means of the block 203 from the operators, on the basis of which information the user selects the operator to be used.

After the information on the user's services has been transferred to the operator, the operator's subscriber information in a subscriber register, such as a home location register HLR of the GSM system, can be changed. Information on a new mobile terminal, such as an IMEI identity, may be transferred to an equipment identity register of the network operator. This embodiment thus enables the user and/or the mobile terminal to be provided with an access possibility to the services of the network operator through the automatic dispenser 100.

The operator's system may transfer the configuration information necessary for using the new or modified network services to the automatic dispenser 100 by using a separate server, e.g. the device management server application 231 of the server 230. The configuration block 202 of the mobile terminal is then responsible for transferring the configuration information to the mobile terminal. The user and the sold mobile terminal can thus be quickly provided with access to a mobile communication network and/or new services. An advantage obtained from the embodiment illustrated above is that correct operator specific settings can be automatically stored in the mobile terminal in the automatic dispenser 100, and no (operator specific) settings for different services have to be maintained in the automatic dispenser 100. Only identification information on the device management servers 230, 231, such as IP addresses or telephone numbers, have to be maintained in the automatic dispenser 100.

In step 307, the mobile terminal may be provided with any settings affecting the operation of the mobile terminal, in accordance with the user and/or the selected services. Examples include browser settings, synchronization settings, e-mail settings, access point settings, and multimedia messaging settings. It is possible to lock a SIM application to a certain mobile terminal to enable the automatic dispenser 100 to configure the mobile terminal to operate together with only one or more determined SIM applications (e.g. together with an application on an IC card obtained from the automatic dispenser 100). The automatic dispenser 100 may also be applied to supplying other electronic devices, in which case any settings necessary therein may be configured by the automatic dispenser 100. Examples include PDA devices, game consoles and digital cameras whose settings can be determined (if the particular device supports this) by the automatic dispenser, wiredly or wirelessly.

If necessary, information generated in the purchase of a mobile terminal or services may also be delivered to information systems 260 of other service providers. For example, information on a mobile terminal and/or a user may be transferred to a server of an operator providing access to the Internet. According to an embodiment, the automatic dispenser 100 may also be arranged to transfer information on a sales event to other devices 260. According to an embodiment, a user is asked for an authorization to deliver information prior to transferring information to an external information system.

According to an embodiment, a user's own IC card or one obtained from the automatic dispenser 100 may also be configured in step 308. As has already been mentioned above, the user may already have an IC card whose information may be modified, or the user may be provided with a new IC card by utilizing the IC cards in the automatic dispenser. The configuration information to be transferred to an IC card may also be provided from the memory of the automatic dispenser 100 and/or an external server 230, 240, 250. Some of the settings to be configured to a mobile terminal (step 307) may physically reside on an IC card, which enables easier use of several terminal devices. The IC card may be provided with settings typically associated with the selected services. In step 308, for instance SIM application information, i.e. mainly information set by a network operator and relating to subscriber management, for example a PLMN list, may be stored on the IC card. Settings of other services and personal user information may also be configured to an IC card.

In step 309, the automatic dispenser may provide the user with a configured mobile terminal and/or an IC card, i.e. control the transfer mechanisms to transfer the mobile terminal to the module 104 and/or the IC card to the module 103.

Information may be transferred to a device managing the automatic dispenser 100 through the management block 206 or to a server collecting sales figures of a device manufacturer.

The method steps illustrated above in connection with FIG. 3 are only one way to implement a sales event in an automatic dispenser 100. The automatic dispenser 100 may e.g. operate only as a vending machine selling mobile terminals, in which case no functions relating to IC cards and services are carried out. The steps may also be executed in a different order, e.g. a user first selects the desired services, and next, the user selects a mobile terminal from among the mobile terminals that are capable of providing the selected services. Since different user needs and operating situations occur, the automatic dispenser 100 may provide menus comprising at least partly different functions, from which the user may proceed as desired. If, for instance, a user already has an IC card of his or her own for purchasing mobile services, and the user does not wish to change the card, only purchase mobile terminal is selected and only functions relating to purchasing a mobile terminal are carried out in the automatic dispenser 100.

FIG. 4 is a flow diagram illustrating a method according to an embodiment of the invention. According to an embodiment, a device management client 208 of an automatic dispenser 100 and an external device management server 231 set up 401 a device management session in accordance with an OMA (Open Mobile Alliance) SyncML DM protocol. The OMA DM protocol specifies a protocol for transferring messages comprising management commands between a client and a management server, as well as XML elements used in these messages, thus enabling uniform operation in different devices supporting this standard.

Step 401 is carried out after the mobile terminal has been selected and it is to be configured (step 307 in FIG. 3). At least information on the type of the selected mobile terminal is delivered 401 to a device management server 231. This step may also comprise transferring information on selected services, which enables a server 230, 231 to select the necessary configuration information for the mobile terminal. The necessary device and/or service information may be delivered already in a message transmitted in order to set up a session, in the SyncML DL protocol in a session setup package (Package #1).

In step 402, the automatic dispenser receives a message comprising at least one management command from the server application 231. Management commands are executed and e.g. settings according to a management command are stored typically in a device comprising the device management client application (208). According to an embodiment, the automatic dispenser 100, more specifically the mobile terminal configuration block 202, is, however, arranged to determine 403, from the received message, the information to be transferred to the mobile terminal. According to an embodiment, the SyncML DM protocol is used, in which case the configuration block 202 may pick all functions determined for management objects from the received packages (Package #2, Package #4) and perform them on the mobile terminal. For the purpose, a data transfer connection is set up 404 to the mobile terminal, enabling the configuration information to be transferred 405 to the mobile terminal.

Typically, a bootstrap process is performed locally on the mobile terminal in step 405, after which the mobile terminal enables services provisioned during the process to be used. For example, a SyncML DM bootstrap may be performed on the mobile terminal, after which it is capable of starting a device management session. Another example is to perform a WAP bootstrap process wherein WAP access settings are configured to the WAP client application of the mobile terminal.

The SyncML DM standard specifies e.g. a Replace command, whose sub-element LocURI specifies the location of the configuration information to be stored and sub-element Data specifies the actual configuration information to be stored. When the configuration block 202 receives a message comprising a Replace command, it checks a resource identifier determined in the LocURI element and replaces the contents of the memory of the mobile terminal at the location according to the LocURI identifier by the configuration information in the Data element. The Data element may then comprise e.g. a file comprising the WAP settings, which is stored in the memory of the mobile terminal by the block 202. The configuration block 202 is also capable of determining functions required by management commands of another type and performing them on the mobile terminal. For more specific details of the SyncML device management elements and commands in particular, reference is made to OMA's specification “SyncML Representation Protocol, Device Management Usage, version 1.1.1”, 2 Oct. 2002, 37 pages. After the configuration information according to the management commands has been transmitted to the mobile terminal, the device management client application 208 may transmit 406 a response message according to the device management protocol to the server application 231. For more specific details of the SyncML device management protocol, reference is made to OMA's specification “SyncML Device Management Protocol, version 1.1.1”, 2 Oct. 2002, 39 pages.

In an embodiment different from what has been disclosed above, a mobile terminal to be configured comprises a device management client application, to which an automatic dispenser 100 delivers management commands received from a device management server application 231. The automatic dispenser 100 may then set up a connection to the device management server 231 which, in turn, subsequently starts the management by a bootstrap process, which is conveyed directly to the mobile terminal by the automatic dispenser 100. Henceforth, a device management session is set up which only occurs between the mobile terminal and the server 231, while the automatic dispenser 100 only delivers information (according to an embodiment, packages specified in the SyncML device management protocol) therebetween. The device management client application of the mobile terminal executes the received management commands, and, subsequently, the mobile terminal has been configured.

FIG. 4 illustrates a method wherein an automatic dispenser 100 receives configuration information from a separate device management server 231. If the configuration information on mobile terminals to be kept in a different automatic dispenser 100 is stored in the memory of the automatic dispenser 100, the configuration may be carried out without an external device management server 230, 231.

As distinct from what has been disclosed above in connection with FIGS. 3 and 4, it is alternatively possible that configuration is carried out from the automatic dispenser 100 only after the user already has the mobile terminal. In such a case, the user may e.g. connect the mobile terminal to a connector in the automatic dispenser 100 to enable configuration information to be transferred to the mobile terminal. The configuration may also be performed through a wireless connection; after the user has switched on the mobile terminal, the automatic dispenser 100 may request connection setup e.g. through an infrared or a Bluetooth connection.

As technology advances, the basic idea of the invention may be implemented in many different ways. Above, reference has been made to identifiers and network element used in the GSM system. The invention may, however, readily be applied to the supply and configuration of mobile terminals and IC cards used therein that operate in networks of another type as well. One such mobile communication technique is a 3GPP (Third Generation Partnership Project) system. The invention and its embodiments are thus not restricted to the examples described above but may vary within the scope of the claims.

1. An automatic dispenser comprises:
a user interface for showing information to a user and for receiving user input in order to select an electronic device,
means for configuring the selected electronic device in response to the user input, and
means for providing the user with the electronic device from the automatic dispenser.

2. An automatic dispenser as claimed in claim 1, the automatic dispenser further comprising:
means for authorizing payment for the electronic device selected by the user.

3. An automatic dispenser as claimed in claim 1, wherein the electronic device is one of the following: a mobile terminal, an IC card, a PDA device, a game console, a camera.

4. An automatic dispenser as claimed in claim 1, wherein the automatic dispenser comprises data transfer means for setting up a data transfer connection with at least one external device.

5. An automatic dispenser as claimed in claim 4, wherein the automatic dispenser comprises a device management client application configured to set up a device management session with a device management server application of an external device, receive device management commands from the server application, and feed information according to the management commands into the electronic device to be configured.

6. An automatic dispenser as claimed in claim 4, wherein the automatic dispenser is configured to transmit at least a user identifier and/or an identifier of the electronic device to at least one external device.

7. An automatic dispenser as claimed in claim 6, wherein the automatic dispenser is configured to show information on different service providers and/or network operators on the user interface, and the automatic dispenser is configured to transmit information to a device of the service provider and/or network operator selected by the user.

8. An automatic dispenser as claimed in claim 1, wherein the automatic dispenser comprises a configuration block to control configuration and an automatic mechanism configured to connect a data cable to a mobile terminal in response to a need to configure an electronic device on the basis of a control signal from the configuration block.

9. A configuration system comprising:
a configuration server,
at least one automatic dispenser supplying electronic devices, wherein
the configuration server and the automatic dispenser are configured to set up a data transfer connection therebetween,
the configuration server is configured to transmit configuration information to the automatic dispenser through the data transfer connection,
the automatic dispenser is configured to receive configuration information from the configuration server, and
the automatic dispenser is configured to feed configuration information to an electronic device to be configured.

10. A method for configuring an electronic device, wherein settings affecting the operation of the electronic device are determined in the electronic device, the method comprising:
selecting an electronic device in an automatic dispenser in accordance with user input received from a user,
configuring, by the automatic dispenser, the electronic device in response to the user input, and
providing the user with the electronic device from the automatic dispenser.

11. A method as claimed in claim 10, the method further comprising:
authorizing payment for the selected device.

12. A method for supplying mobile terminals to end users, wherein an automatic dispenser with mobile terminals is provided, the method comprising:
selecting a mobile terminal in the automatic dispenser, and
providing a user with the mobile terminal from the automatic dispenser.

13. A method as claimed in claim 12, the method comprising:
configuring the mobile terminal by employing information determined for the user in the automatic dispenser.

14. A method as claimed in claim 12, the method comprising:
selecting a network operator in the automatic dispenser, and transmitting user information to a device of the selected network operator.

15. A method as claimed in claim 14, wherein at least a user identifier and/or a mobile terminal identifier is transmitted to the device of the network operator, and
the user and/or the mobile terminal is provided with access to services of the network operator.

16. A computer program product for controlling an automatic dispenser in response to executing a program code in the computer program product in the automatic dispenser, the computer program product comprising:
a program code portion for controlling the automatic dispenser to select an electronic device on the basis of user input received from a user,
a program code portion for controlling the automatic dispenser to configure an electronic device in response to the user input, and
a program code portion for controlling the automatic dispenser to provide the user with the electronic device.

17. A computer program product as claimed in claim 16, wherein the computer program further comprises a program code portion for controlling the automatic dispenser to authorize payment for the electronic device.
